(19) United States
(12) Patent Application Publication
(10) Pub. No.: US 2004/0073570 A1
(43) Pub. Date: Apr. 15, 2004

(54) System and method for blind sharing of genome data

(75) Inventors: Janani Janakiraman, Austin, TX (US); David Bruce Kumhyr, Austin, TX (US); Margaret Gardner MacPhail, Corpus Christi, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/268,234

(22) Filed: Oct. 10, 2002

(51) Int. Cl. G06F 17/00; G06F 7/00

(52) U.S. Cl. 707/104.1

(57) ABSTRACT

A system and method for blindly sharing biological data is provided. Biological data, such as such as genome data, proteome data, and genetic data is licensed by a data provider to one or more data consumers without compromising the identity of either party. A trusted third party, or data broker, is used to manage the biological data developed by data providers. The trusted third party/data broker receives requests from data consumers, such as researchers, and matches the requests against available data. If the data consumer decides to license the data, the data broker digitally signs the license agreement on behalf of each party in accordance with the intellectual property and pricing terms specified by the data provider. In addition, the trusted third party/data broker may be used to manage the data consumer's access of the data.

### BACKGROUND OF THE INVENTION

1. Technical Field

The present invention relates in general to a system and method for sharing data. More particularly, the present invention relates to a system and method for sharing biological genome data while cloaking the identity of the consumer and the provider.

2. Description of the Related Art

An impediment to rapid development of genetic information is proprietary and intellectual property rights coupled to such information. For the owners, these rights hold vast potential for economic gain. Guarding the use of such genetic information, however, thwarts researchers in their efforts to rapidly discover cures and other medical breakthroughs that would otherwise be gained through cooperative efforts.

Biological research, such as research to discover new treatments or cures for diseases and other ailments, are often tightly guarded secrets by the research organizations performing the research. The research organization often does not want competing organizations to discover the research projects being undertaken. Keeping research projects secret enables an organization to gain a competitive advantage by, hopefully, being the first to gain governmental approval and market a new drug. This, in turn, leads to enormous profits when the organization is the only pharmaceutical firm with a drug to treat a particular disease or ailment.

Additionally, pharmaceutical firms and medical researchers may research in sensitive areas of development, such as research regarding tobacco usage or new tobacco products. These firms and researchers may not want their research to be publicly disclosed. When these firms and researchers license biological data from data providers, it is difficult to keep the research secret. Often, the type of data being acquired indicates the kind of research being performed. Similarly, data providers may face adverse scrutiny if it is known that the provider is or has provided its data to researchers performing research in sensitive areas.

What is needed, therefore, is a system and method that allows blind sharing of biological data. Specifically, what is needed is a system and method that allows researchers and other data consumers to analyze potential data sources without being identified and license data that it deems helpful for research. The system and method also needs to allow the data provider to remain anonymous while still maintaining its intellectual property rights and receiving licensing payments and royalties.

### SUMMARY

It has been discovered that biological data, such as such as genome data, proteome data, pharmaceutical data, and genetic data can be licensed by a data provider to one or more data consumers without compromising the identity of either party. A trusted third party, or data broker, is used to manage the biological data developed by data providers. The trusted third party/data broker receives requests from data consumers, such as researchers, and matches the requests against available data. Metadata is data that describes the data that is available for licensing. Metadata may include descriptions, summaries, field information, pricing data, and intellectual property terms for licensing the data.

The trusted third party/data broker provides metadata to the data consumer so that the data consumer can decide whether to license the data. If the data consumer decides to license the data, the trusted third party/data broker digitally signs the license agreement on behalf of each party in accordance with the intellectual property and pricing terms specified by the data provider.

The trusted third party/data broker receives the licensed data from the data provider and provides it to the data consumer for biological research. In addition, the trusted third party/data broker may be used to manage the data consumer's access of the data. In this manner, the data consumer receives the data without knowing the identity of the data provider. Likewise, the data provider is able to license the data and receive money and intellectual property rights from the data consumer without having to know the identity of the consumer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a high level diagram of transactions between a data provider and a consumer managed by a data broker;

FIG. 2 is a network diagram of a data broker brokering research data between providers and a researcher;

FIG. 3 is a high level diagram of providers' metadata provided to a consumer through a data broker;

FIG. 4 is a high level diagram of data being provided to a consumer through a data broker;

FIG. 5 is a flowchart showing steps taken by a consumer to register with a data broker;

FIG. 6 is a flowchart showing steps taken by a data provider in registering itself and its data with a data broker;

FIG. 7 is a flowchart showing steps taken by a consumer requesting metadata through a data broker;

FIG. 8 is a flowchart showing steps taken by a consumer to analyze metadata and license data through a data broker; and

FIG. 9 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

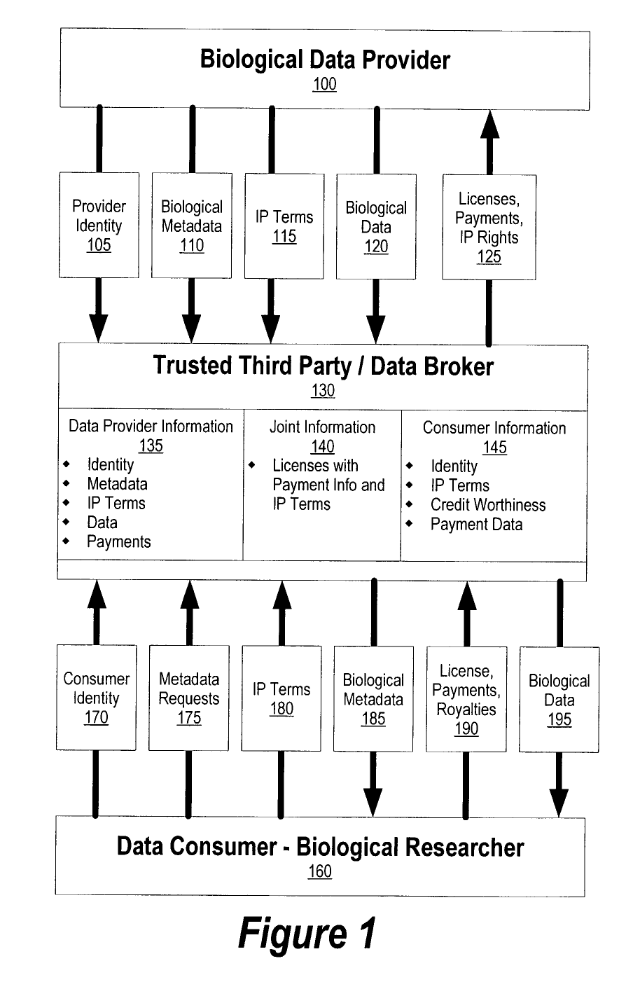

FIG. 1 is a high level diagram of transactions between a data provider and a consumer managed by a data broker. Biological data provider 100 provides information to trusted third party 130, such as a biological data broker. Biological data provided by the provider includes the provider's identity (105), metadata describing the provider's data (110), intellectual property terms for licensing the data (115), and biological data (120), such as genome data, proteome data, genetic data, pharmaceutical data, and biological data. Provider identity 105 includes the provider's name, address, telephone number, and electronic address. In addition, the provider can include data such as the provider's affiliations, quality ratings, qualifications, data testing procedures, and the like. The qualifications may be shared with prospective data consumers without informing the consumers of the actual identity of the data provider.

Trusted third party 130, such as a biological data broker, receives the data provider's information and stores in data provider information storage area 135. Trusted third party 130 receives requests from data consumer 160, such as a biological researcher. Data consumer 160 provides the consumer's identity (170), metadata requests (175), and required intellectual property licensing terms (180) to trusted third party 130. Consumer identity 170 includes the consumer's name, organization, address, telephone number, and electronic address. Similar to provider qualifications, the consumer can include data such as the consumer's affiliations, experience, qualifications, credentials, and the like. The qualifications may be shared with data providers without informing the providers of the actual identity of the consumer. The trusted third party (130) stores the received consumer information in nonvolatile storage area 145.

Trusted third party 130 matches metadata requests 175 and needed intellectual property terms 180 with biological metadata received from various data providers. Matching biological metadata 185 is returned to the consumer. The metadata includes the intellectual property terms needed to license the data, fees for licensing the data, and descriptive information about the data. The metadata does not, however, identify the provider of the data. The metadata may also include analyses or reviews of the data that have been performed by the trusted third party or by other organizations.

When the data consumer finds data that he wishes to license, the data consumer sends an agreement for the data, including data consumer's IP terms (180) that are acceptable to the provider, along with payments and other royalties (190). The license is electronically signed by the trusted third party on behalf of the anonymous data provider and stored in joint information 140. A copy of the license, without the consumer's identity information, is also electronically signed by the trusted third party on behalf of the data consumer and sent to data provider 100 along with payments (information flow 125). Licensed biological data 195 corresponding to the license agreement is then provided from the data provider, through the trusted third party, to the data consumer in a secured manner. The licensed data may be provided in a controlled manner so that wholesale copying of the data is monitored and prevented.

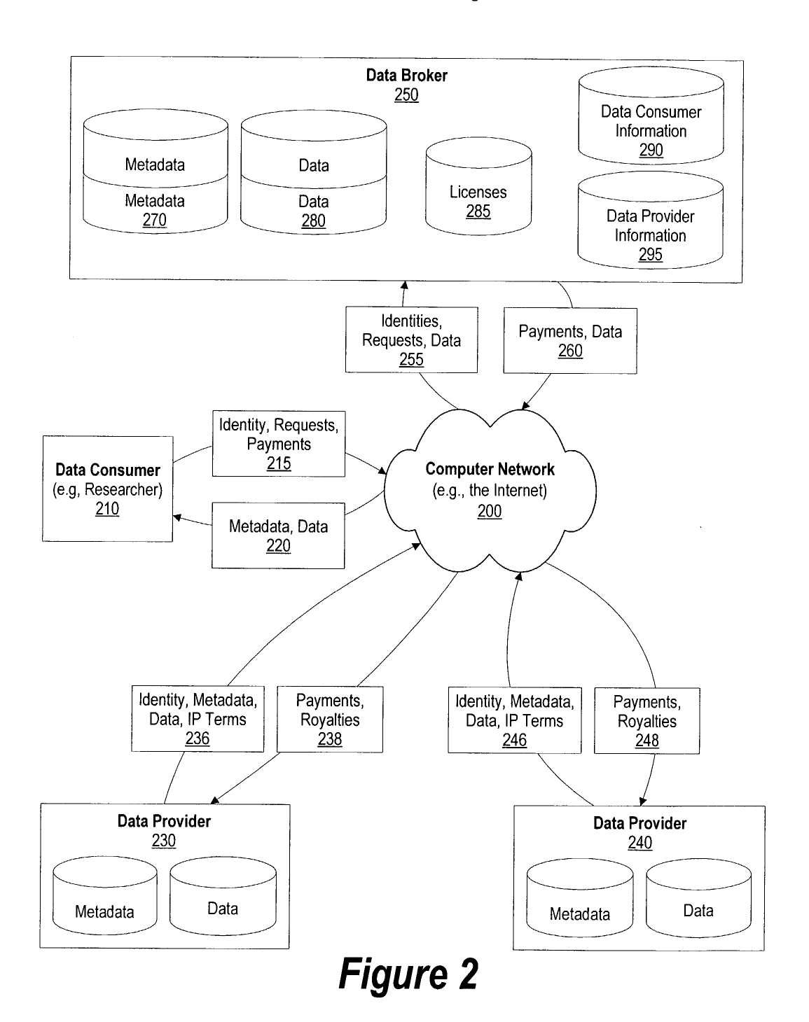

FIG. 2 is a network diagram of a data broker brokering research data between providers and a researcher. Computer network 200, such as the Internet, is used to interconnect data consumer 210, data broker 250, and data providers (230 and 240). Data broker 250 acts as a trusted third party for licensing data and providing the data from the providers to the consumer without exchanging identity information about the parties.

Data consumer 210, such as a genetic researcher, sends his identity, data requests, and payments (message 215) through computer network 200 to data broker 250. Likewise, data providers 230 and 240 provide their identity, metadata, and intellectual property licensing terms (messages 236 and 246, respectively) through computer network 200 to data broker 250.

Data broker receives identities, requests, and data (message 255) from the consumer and providers. Data consumer information is stored in nonvolatile data store 290 and the providers' information in nonvolatile data store 295. Metadata received from the providers is stored in nonvolatile data store 270 and research data received from providers is stored in nonvolatile data store 280. Metadata is stored in a retrievable format, such as Extensible Markup Language (XML), a flat file, or in a database file, such as a relational database table or a hierarchical database file. When desired data and intellectual property terms are found by a data consumer, an agreement is entered into with the data broker signing, either on a paper document or electronically, the license agreement on behalf of both parties. Completed licenses are stored in license nonvolatile data store 285.

Data, including licensed data and metadata, are securely sent by data broker 250 (message 260) to the data consumer through computer network 200. Data consumer 210 receives metadata and data from the computer network (message 220). Likewise, payments, including royalty payments, are electronically and securely wired by data broker 250 (message 260) to the correct data provider through computer network 200. Data providers 230 and 240 receive wired payments from the computer network (messages 238 and 248, respectively).

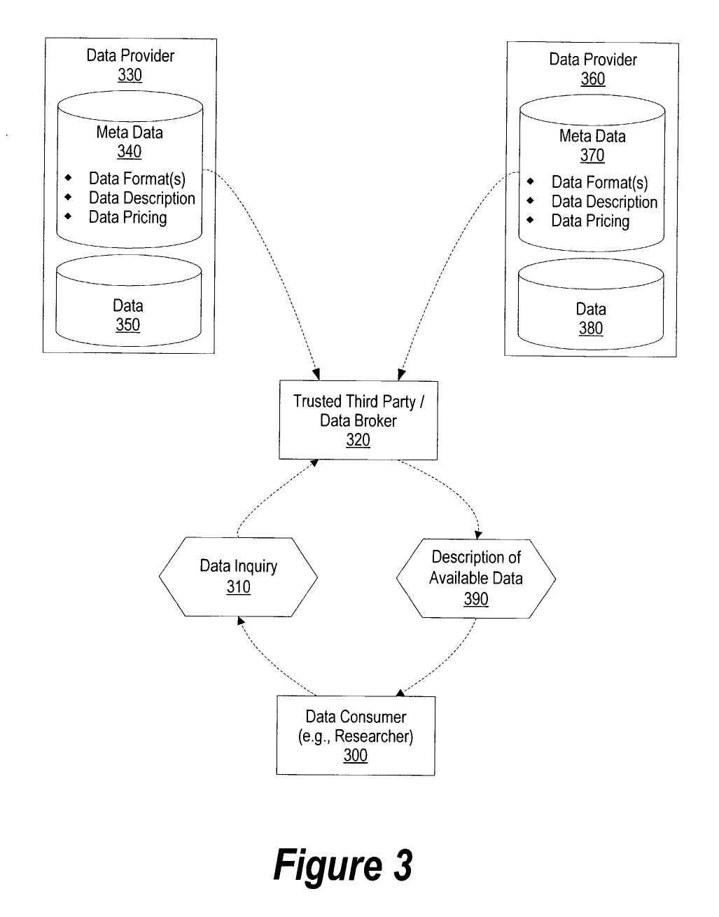

FIG. 3 is a high level diagram of providers' metadata provided to a consumer through a data broker. Data consumer 300, such as a researcher, sends data inquiry message 310 to data broker 320. Data broker retrieves, either before the request or in response to the request, metadata 340 and 370 from data providers 330 and 360, respectively.

Metadata includes data format information, a description of the data including any third party reviews or analyses that have been performed to validate the data, and pricing terms. In addition, metadata includes intellectual property terms that are to be included in any subsequent license for the corresponding data (350 and 360, respectively).

Data broker 320 responds to the consumer's inquiry message 310 with metadata describing the available data as well as pricing and intellectual property terms that apply to the data (message 390). Data consumer 300 receives the data description message(s) and analyzes the descriptions in order to decide which sets of research data to license.

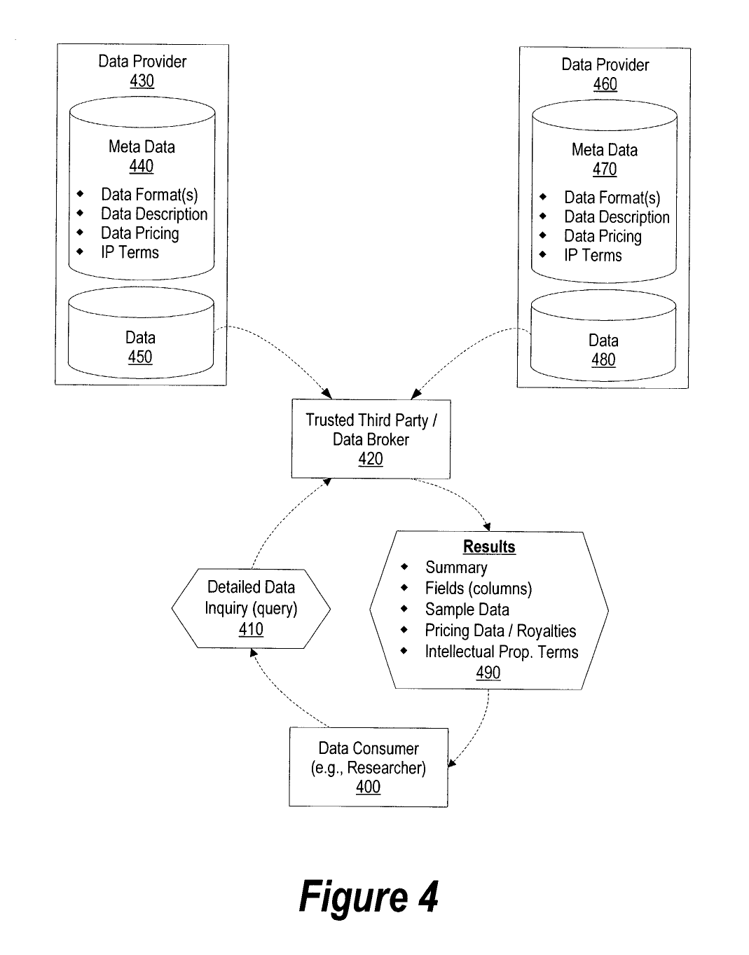

FIG. 4 is a high level diagram of data being provided to a consumer through a data broker. In response to receiving descriptions regarding available research data, data consumer 400 sends detailed data inquiry (message 410) to data broker 420. The detailed data inquiry corresponding to one or more sets of metadata (440 and 470) that were provided to the consumer in FIG. 3. Data broker retrieves detailed descriptive data regarding the research data (450 and 480) available from the providers (430 and 460, respectively).

Further metadata, such as a summary, fields (i.e., columns), samples, detailed pricing and royalty terms, and detailed intellectual property terms, are retrieved for the available sets of research data and sent by data broker 420 to the data consumer in message 490. The data consumer receives the detailed results, including sample data, in message 490. The data consumer now has most, if not all, the information needed to decide which set of research data to license.

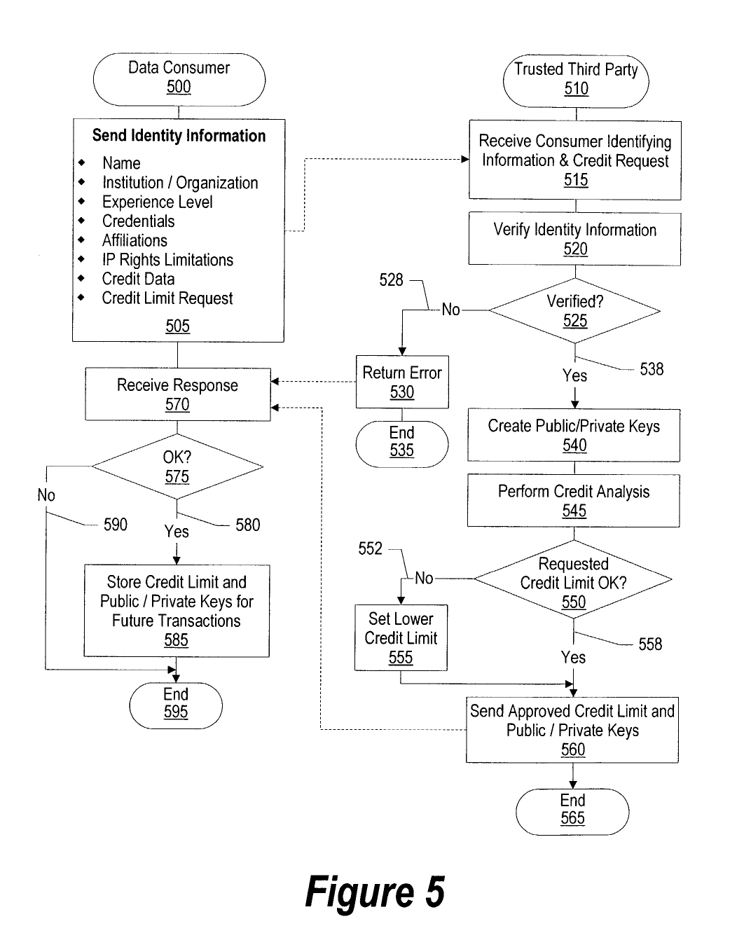

FIG. 5 is a flowchart showing steps taken by a consumer to register with a data broker. Data consumer processing commences at 500 whereupon the data consumer sends identity information to the trusted third party/data broker (step 505). Trusted third party/data broker processing commences at 510 whereupon the broker receives the consumer's identity information and credit request (step 515). The trusted third party/data broker verifies the identity information (step 520). For example, a credit card and address can be used to verify the consumer's identity. In addition, a digital certificate corresponding to the consumer can be provided (i.e., a digital signature) and verified with a digital certificate issuer.

A determination is made as to whether the consumer's identity was verified (decision 525). If the identity was not verified, decision 525 branches to “no” branch 528 whereupon an error is returned to the consumer (step 530) and trusted third party/data broker processing ends at 535.

On the other hand, if the consumer's identity is verified, decision 525 branches to “yes” branch 538 to process the consumer's request. A set of public and private keys are created to secure data transmitted between the trusted third party/data broker and the data consumer as well as to digitally sign documents (step 540). A credit analysis is performed to determine how much credit should be extended to the data consumer (step 545). A determination is made as to whether the amount of credit requested by the data consumer is approved (decision 550). If the amount of credit is not approved, decision 550 branches to “no” branch 552 whereupon a lower credit limit is provided (step 555). The amount of credit available to the data consumer determines the various available sets of biological and genetic data that the data consumer is able to license. A secure message is returned to the data consumer with the amount of credit approved for the consumer as well as encryption keys to use in future transactions (step 560). Trusted third party/data broker processing ends at 565.

Returning to data consumer processing, the data consumer receives a response from the trusted third party/data broker at step 570. A determination is made as to whether the data consumer's request was accepted (decision 575). If the data consumer's request was accepted, decision 575 branches to “yes” branch 580 whereupon the data consumer's credit limit and private/public keys are stored for future transactions (step 585). On the other hand, if the data consumer's request was not accepted, decision 575 branches to “no” branch 590 indicating that an error occurred. Data consumer processing ends at 595.

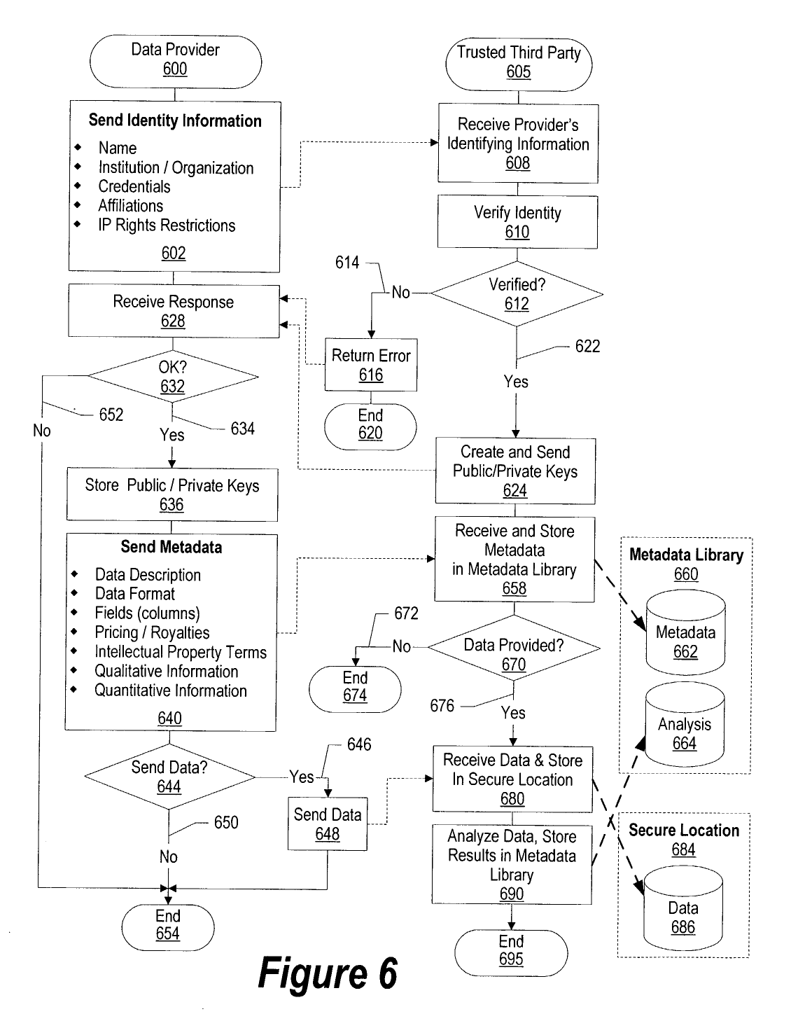

FIG. 6 is a flowchart showing steps taken by a data provider in registering itself and its data with a data broker. Data provider processing commences at 600 whereupon the data provider sends identity information to the trusted third party/data broker (step 602). Trusted third party/data broker processing commences at 605 whereupon the broker receives the provider's identity information (step 608). The trusted third party/data broker verifies the identity information (step 610). For example, a credit card and address can be used to verify the provider's identity. In addition, a digital certificate corresponding to the provider can be provided (i.e., a digital signature) and verified with a digital certificate issuer.

A determination is made as to whether the provider's identity was verified (decision 612). If the identity was not verified, decision 612 branches to “no” branch 614 whereupon an error is returned to the provider (step 616) and trusted third party/data broker processing ends at 620.

On the other hand, if the provider's identity is verified, decision 612 branches to “yes” branch 622 to process the provider's request. A set of public and private keys are created to secure data transmitted between the trusted third party/data broker and the data provider as well as to digitally sign documents (step 624).

Returning to data provider processing, the data provider receives a response from the trusted third party/data broker at step 628. A determination is made as to whether the data provider's request was accepted (decision 632). If the data provider's request was not accepted, decision 632 branches to “no” branch 652 bypassing the remaining processing and indicating that an error occurred.

On the other hand, if the data provider's request was accepted, decision 632 branches to “yes” branch 634 whereupon the data provider's private/public keys are stored for future transactions (step 636). Metadata corresponding to data that the data provider wishes to license is sent to the trusted third party/data broker (step 640). Metadata includes a description of the data, the data format, the fields (columns) included with the data, pricing/royalty information, intellectual property terms that the data provider requires in license agreements for the data, and qualitative and quantitative information. Qualitative information may include data regarding reviews or analyses that have been performed on the data or other quality assurance measures that have been taken. Qualitative information includes the number of data records and range of data collected. A determination is made as to whether the data provider wishes to have the trusted third party/data broker store the actual data (decision 644). If the data provider wishes for the trusted third party/data broker to store the actual data, decision 644 branches to “yes” branch 646 whereupon the data is sent to the trusted third party/data broker (step 648). On the other hand, if the data provider is not providing the actual data to the trusted third party/data broker, decision 644 branches to “no” branch 650. Data provider processing subsequently ends at 654.

Returning to trusted third party/data broker processing, the trusted third party/data broker receives the metadata sent by the data provider and stores the data in metadata library 660 as metadata file 662 (step 658). A determination is made as to whether the data provider sent the actual data for storage by the trusted third party/data broker (decision 670). If the data was not provided, decision 670 branches to “no” branch 672 whereupon processing ends at 674. On the other hand, if the data provider did provide the data, decision 670 branches to “yes” branch 676 whereupon the data is received and stored in secure location 684 as data file 686 (step 680). The trusted third party/data broker then analyzes the data to verify that the metadata provided by the data provider is correct as well as to generate additional metadata that was not provided by the data provider (step 690). The analysis and additional metadata is stored in metadata library 660 as analysis data file 664. Trusted third party/data broker ends at 695.

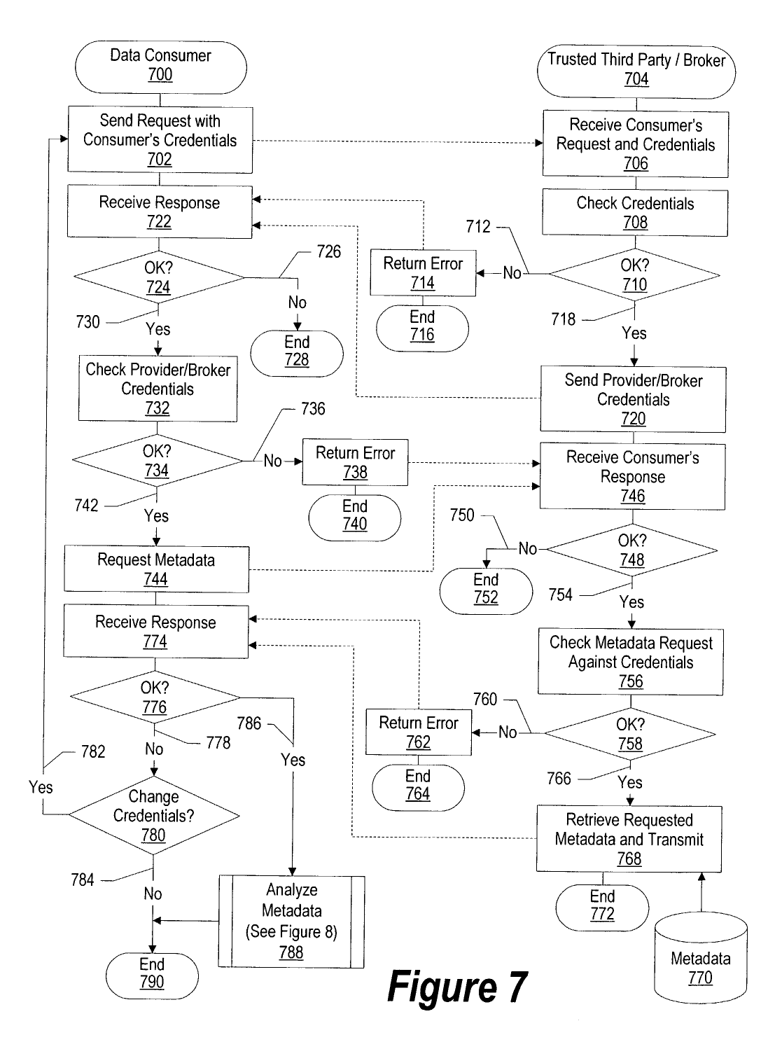

FIG. 7 is a flowchart showing steps taken by a consumer requesting metadata through a data broker. Data consumer processing commences at 700 whereupon the data consumer sends a request for metadata along with the consumer's credentials (step 702). The credentials can be public key/private key information (i.e., a digital signature) or some other credential used to establish the identity of the consumer.

Trusted third party/data broker processing commences at 704 whereupon the trusted third party/data broker receives the consumer's request for metadata along with the consumer's credentials. The trusted third party/data broker checks the received credentials (step 708) and a determination is made as to whether the credentials are valid (decision 710). If the credentials are not valid, decision 710 branches to “no” branch 712 whereupon an error is returned to the data consumer (step 714) and trusted third party/data broker processing ends at 716. On the other hand, if the consumer's credentials are valid, decision 710 branches to “yes” branch 718 whereupon the trusted third party/data broker responds by sending its credentials (i.e., digital signature) back to the data consumer (step 720).

Returning to data consumer processing, the data consumer receives a response from the trusted third party/data broker at step 722. A determination is made as to whether the consumer's request and credentials were accepted (decision 724). If the consumer's request and credentials were not accepted, decision 724 branches to “no” branch 726 and data consumer processing ends at 728. On the other hand, if the consumer's request and credentials were accepted, decision 724 branches to “yes” branch 730 whereupon the credentials, such as a digital certificate or signature, supplied by the trusted third party/data broker are checked (step 732). A determination is made as to whether the credentials provided by the trusted third party/data broker are valid (decision 734). If the credentials are not valid, decision 734 branches to “no” branch 736 whereupon an error is returned to the trusted third party/data broker (step 738) and data consumer processing ends at 740. On the other hand, if the credentials supplied by the trusted third party/data broker are valid, decision 734 branches to “yes” branch 742 whereupon the data consumer requests metadata from the trusted third party/data broker (step 744).

Returning to trusted third party/data broker processing, the trusted third party/data broker receives the consumer's response at step 746. A determination is made as to whether the trusted third party/data broker's credentials were accepted by the data consumer (decision 748). If the credentials were not accepted, decision 748 branches to “no” branch 750 whereupon trusted third party/data broker processing ends at 752. On the other hand, if the credentials were accepted by the data consumer, the metadata request sent by the data consumer is received and checked against the data consumer's credentials (step 756). For example, the data consumer may be requesting metadata for a data set that is more expensive than the data consumer's current credit level. A determination is made as to whether the consumer's credentials are sufficient in light of the requested metadata (decision 758). If the data consumer's credentials are insufficient, decision 758 branches to “no” branch 760 whereupon an error is returned to the data consumer (step 762) and trusted third party/data broker processing ends at 764. On the other hand, if the data consumer's credentials are sufficient, decision 758 branches to “yes” branch 766 whereupon the requested metadata is retrieved from metadata store 770 and transmitted to the data consumer (step 768). Trusted third party/data broker processing thereafter ends at 772.

Returning to data consumer processing, the data consumer receives a response from the trusted third party/data broker (step 774). A determination is made as to whether the response is an error indicating insufficient consumer credentials (decision 776). If an error was received, decision 776 branches to “no” branch 778 whereupon a determination is made as to whether the consumer wishes to change his credentials (decision 780). A change in credentials may supply additional credit information in order to receive a higher credit limit and, thereby, be able to receive the requested metadata. If the consumer wishes to change is credentials, decision 780 branches to “yes” branch 782 which loops back to resend the request with additional credential information. On the other hand, if the consumer does not want to change his credentials, decision 780 branches to “no” branch 784 bypassing the resending of the request.

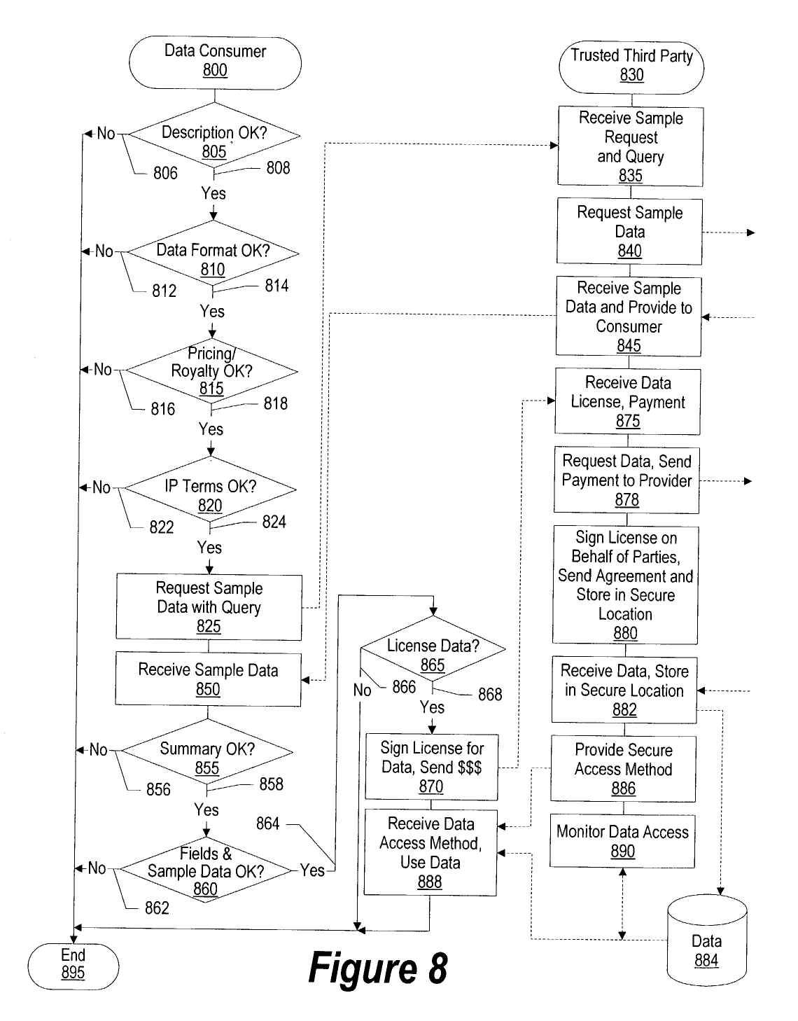

Returning to decision 776, if the consumer received metadata from the trusted third party/data broker, decision 776 branches to “yes” branch 786 whereupon the metadata is analyzed (predefined process 788, see FIG. 8 for processing details). Data consumer processing ends at 790.

FIG. 8 is a flowchart showing steps taken by a consumer to analyze metadata and license data through a data broker. Data consumer processing commences at 800 whereupon the data consumer checks the description of the data and determines whether it is acceptable for the research being performed (decision 805). If the description is not acceptable, decision 805 branches to “no” branch 806 whereupon data consumer processing ends at 895.

If the description is acceptable, decision 805 branches to “yes” branch 808 whereupon the data consumer determines whether the format of the data is acceptable (decision 810). If the data format is not acceptable, decision 810 branches to “no” branch 812 whereupon data consumer processing ends at 895.

If the data format is acceptable, decision 810 branches to “yes” branch 814 whereupon the data consumer determines whether the pricing and royalty terms to license the data are acceptable (decision 815). If the pricing and royalty terms are not acceptable, decision 815 branches to “no” branch 816 whereupon data consumer processing ends at 895.

If the pricing and royalty terms are acceptable, decision 815 branches to “yes” branch 818 whereupon the data consumer determines whether the intellectual property licensing terms for the data are acceptable in light of the data consumer's research (decision 820). If the intellectual property licensing terms are not acceptable, decision 820 branches to “no” branch 822 whereupon data consumer processing ends at 895. If the intellectual property terms and any other concerns of the data consumer are satisfied with respect to the data, decision 820 branches to “yes” branch 824 whereupon sample data is requested from the trusted third party/data broker (step 825).

Trusted third party/data broker processing commences at 830 whereupon the trusted third party/data broker receives the data consumer's request for sample data with a query for the kind of data the data consumer would like to use in his research (step 835). The sample data is requested (step 840). If the trusted third party/data broker maintains a copy of the data on behalf of the data provider, the trusted third party/data broker retrieves the sample data from a secured data storage area accessible by the trusted third party/data broker. Otherwise, the trusted third party/data broker requests the sample data from the data provider. The sample data is received and sent to the data consumer (step 845).

Returning to data consumer processing, the data consumer receives the sample data from the trusted third party/data broker (step 850). The data consumer determines whether the summary of the data that can be provided is acceptable in light of the data consumer's research goals (decision 855). If the summary of the data is not acceptable, decision 855 branches to “no” branch 856 whereupon processing ends at 895. Otherwise, decision 855 branches to “yes” branch 858 whereupon the data consumer determines if the fields returned and the sample data show that the data will be acceptable for the data consumer's research (decision 860). If the fields and sample data are not acceptable, decision 860 branches to “no” branch 862 whereupon processing ends at 895.

Otherwise, if the data is acceptable, decision 860 branches to “yes” branch 864 whereupon the data consumer decides whether to license the data given the sample data, the price of the data, and the intellectual property terms required to license the data (decision 865). If the data consumer decides not to license the data, decision 865 branches to “no” branch 866 whereupon processing ends at 895. On the other hand, if the data consumer decides to license the data, decision 865 branches to “yes” branch 868 whereupon the data consumer digitally signs the license agreement corresponding to the research data and sends the license data and payment data to the trusted third party/data broker for processing (step 870).

Returning to trusted third party/data broker processing, the trusted third party/data broker receives the license agreement signed by the data consumer and the payment (step 875). The trusted third party/data broker sends a payment to the data provider and, if the trusted third party/data broker does not have a copy of the data, requests a copy of the data from the data provider (step 878). The payment might not be the same as the payment received from the data consumer if, for example, the trusted third party/data broker receives a commission or a fee for performing the brokerage services. The trusted third party/data broker signs the agreement on behalf of each party so that the identity of each party is not revealed to the other party, sends the agreements to the respective parties, and stores the agreements in a secure location (step 880). Licensed data 884 is received and stored secure location (step 882). A secure access method, for example requiring a digital signature or a password, is provided to the data consumer (step 886). The trusted third party/data broker monitors the data access to ensure that the data consumer is abiding by conditions or restrictions placed on the data (step 890). For example, the data provider may restrict licensees from copying all or a significant portion of the data.

Returning to data consumer processing, the data consumer receives the access method from the trusted third party/data broker and uses the data in accordance with usage restrictions placed on the data (step 888) Data consumer processing thereafter ends at 895.

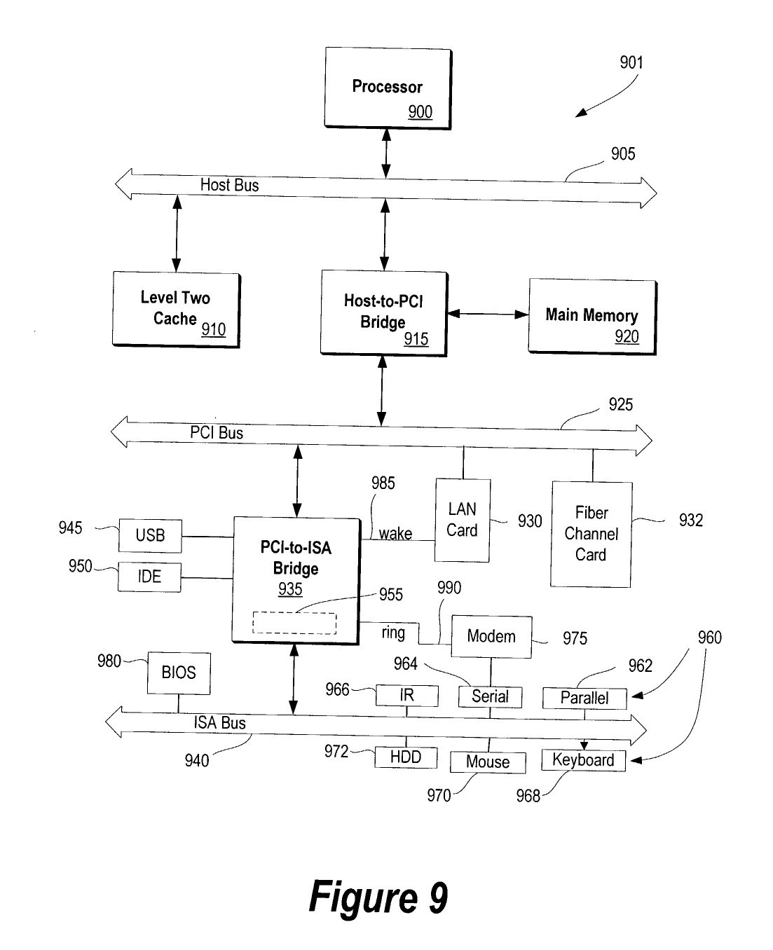

FIG. 9 illustrates information handling system 901 which is a simplified example of a computer system capable of performing the operations described herein. Computer system 901 includes processor 900 which is coupled to host bus 905. A level two (L2) cache memory 910 is also coupled to the host bus 905. Host-to-PCI bridge 915 is coupled to main memory 920, includes cache memory and main memory control functions, and provides bus control to handle transfers among PCI bus 925, processor 900, L2 cache 910, main memory 920, and host bus 905. PCI bus 925 provides an interface for a variety of devices including, for example, LAN card 930. PCI-to-ISA bridge 935 provides bus control to handle transfers between PCI bus 925 and ISA bus 940, universal serial bus (USB) functionality 945, IDE device functionality 950, power management functionality 955, and can include other functional elements not shown, such as a real-time clock (RTC), DMA control, interrupt support, and system management bus support. Peripheral devices and input/output (I/O) devices can be attached to various interfaces 960 (e.g., parallel interface 962, serial interface 964, infrared (IR) interface 966, keyboard interface 968, mouse interface 970, fixed disk (HDD) 972 coupled to ISA bus 940. Alternatively, many I/O devices can be accommodated by a super I/O controller (not shown) attached to ISA bus 940.

BIOS 980 is coupled to ISA bus 940, and incorporates the necessary processor executable code for a variety of low-level system functions and system boot functions. BIOS 980 can be stored in any computer readable medium, including magnetic storage media, optical storage media, flash memory, random access memory, read only memory, and communications media conveying signals encoding the instructions (e.g., signals from a network). In order to attach computer system 901 to another computer system to copy files over a network, LAN card 930 is coupled to PCI bus 925 and to PCI-to-ISA bridge 935. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for providing data without identifying a data consumer to a data provider, said method comprising:
receiving, at a trusted third party, a data request from the data consumer;
comparing the data request with one or more data sources offered by one or more data providers;
creating a data reply based upon the comparing; and
sending, from the trusted third party, the data reply to the data consumer.

2. The method as described in claim 1 wherein the data sources include a data type and wherein the data type is selected from the group consisting of genome data, proteome data, pharmaceutical data, genetic data, and biological data.

3. The method as described in claim 1 wherein the data reply includes metadata, the method further comprising:
including data pricing data and licensing terms in the metadata;
receiving, at the trusted third party, data consumer qualifications corresponding to the data consumer;
evaluating the data consumer qualifications based upon the data pricing data and the licensing terms; and
selecting the one or more data sources based upon the evaluation.

4. The method as described in claim 1 further comprising:
receiving, at the trusted third party, a data licensing agreement from the data consumer;
storing the data agreement; and
providing the data consumer with one or more data files corresponding to one of the data sources.

5. The method as described in claim 4 further comprising:
receiving, at the trusted third party, a licensing payment from the data consumer; and
sending at least a portion of the payment to the data provider.

6. The method as described in claim 1 wherein the data provider is not identified to the data consumer, the method further comprising:
receiving, at the trusted third party, data provider qualifications corresponding to the data provider; and
providing the data provider qualifications to the data consumer in response to the request.

7. The method as described in claim 1 wherein the data sources include at least one metadata element selected from the group consisting of a data summary, data fields, a data price, a data royalty, and an intellectual property right licensing term.

8. An information handling system comprising:
one or more processors;
a memory accessible by the processors;
a nonvolatile storage device accessible by the processors;
a network interface for sending and receiving data over a computer network;
an data brokerage tool for providing data without identifying a data consumer to a data provider, the automation tool including:
means for receiving, at the information handling system, a data request from the data consumer through the network interface;
means for comparing the data request with one or more data sources offered by one or more data providers;
means for creating a data reply based upon the comparing; and
means for sending the data reply to the data consumer through the network interface.

9. The information handling system as described in claim 8 wherein the data sources include a data type and wherein the data type is selected from the group consisting of genome data, proteome data, genetic data, pharmaceutical data, and biological data.

10. The information handling system as described in claim 8 wherein the data reply includes metadata, the information handling system further comprising:
means for including data pricing data and licensing terms in the metadata;
means for receiving, through the network interface, data consumer qualifications corresponding to the data consumer;
means for evaluating the data consumer qualifications based upon the data pricing data and the licensing terms; and
means for selecting the one or more data sources based upon the evaluation.

11. The information handling system as described in claim 8 further comprising:
means for receiving, through the network interface, a data licensing agreement from the data consumer;
means for storing the data agreement; and
means for providing the data consumer with one or more data files corresponding to one of the data sources.

12. The information handling system as described in claim 11 further comprising:
means for receiving a licensing payment from the data consumer; and
means for sending at least a portion of the payment to the data provider.

13. The information handling system as described in claim 8 wherein the data provider is not identified to the data consumer, the information handling system further comprising:
means for receiving, through the network interface, data provider qualifications corresponding to the data provider; and
means for providing the data provider qualifications to the data consumer in response to the request.

14. A computer program product stored on a computer operable media for providing data without identifying a data consumer to a data provider, said computer program product comprising:
means for receiving, at a trusted third party, a data request from the data consumer;
means for comparing the data request with one or more data sources offered by one or more data providers;
means for creating a data reply based upon the comparing; and
means for sending, from the trusted third party, the data reply to the data consumer.

15. The computer program product as described in claim 14 wherein the data sources include a data type and wherein the data type is selected from the group consisting of genome data, proteome data, genetic data, pharmaceutical data, and biological data.

16. The computer program product as described in claim 14 wherein the data reply includes metadata, the computer program product further comprising:
means for including data pricing data and licensing terms in the metadata;
means for receiving, at the trusted third party, data consumer qualifications corresponding to the data consumer;
means for evaluating the data consumer qualifications based upon the data pricing data and the licensing terms; and
means for selecting the one or more data sources based upon the evaluation.

17. The computer program product as described in claim 14 further comprising:
means for receiving, at the trusted third party, a data licensing agreement from the data consumer;
means for storing the data agreement; and
means for providing the data consumer with one or more data files corresponding to one of the data sources.

18. The computer program product as described in claim 17 further comprising:
means for receiving, at the trusted third party, a licensing payment from the data consumer; and
means for sending at least a portion of the payment to the data provider.

19. The computer program product as described in claim 14 wherein the data provider is not identified to the data consumer, the computer program product further comprising:
means for receiving, at the trusted third party, data provider qualifications corresponding to the data provider; and
means for providing the data provider qualifications to the data consumer in response to the request.

20. The computer program product as described in claim 14 wherein the data sources include at least one metadata element selected from the group consisting of a data summary, data fields, a data price, a data royalty, and an intellectual property right licensing term.
